(19) United States
(12) Patent Application Publication
(10) Pub. No.: US 2019/0299153 A1
(43) Pub. Date: Oct. 3, 2019

(54) LAYERED ADSORBENT BED FOR REMOVAL OF CARBON DIOXIDE AND HEAVY HYDROCARBONS

(71) Applicant: UOP LLC, Des Plaines, IL (US)

(72) Inventors: Shain-Jer Doong, Kildeer, IL (US); Qing Xu, Mount Prospect, IL (US)

(21) Appl. No.: 15/938,873

(22) Filed: Mar. 28, 2018

(51) Int. Cl. B01D 53/04; B01D 53/62; B01D 53/72

(52) U.S. Cl. CPC B01D 53/0454; B01D 53/62; B01D 53/72; B01D 2253/1085; B01D 2259/4146; B01D 2257/7027; B01D 2258/018; B01D 2259/401; B01D 2257/504

(57) ABSTRACT

A process for treating a natural gas stream comprising sending said gas stream through at least one multi-layered adsorbent bed comprising at least one layer of an adsorbent preferentially adsorbing C8+ hydrocarbons and aromatics over other impurities, at least one layer of a zeolite preferentially adsorbing carbon dioxide over other impurities and at least one layer of a zeolite preferentially removing C7− hydrocarbons over other impurities to produce a gas stream comprising methane.

### BACKGROUND OF THE INVENTION

In liquefied natural gas (LNG) peak shaver plants, thermal swing adsorption (TSA) processes have been widely used for removal of water and carbon dioxide from natural gas to prevent freezing in LNG production. Such peak shaving plants are used to process and store surplus natural gas so as to be able to meet the requirements of peak consumption during cold winters and extreme summer heat. The typical adsorbent used for this application is either 4A or 13X zeolite molecular sieves. Due to the much lower carbon dioxide adsorption capacity than water, removal of carbon dioxide generally governs the design of the adsorption beds. In the absence of hydrocarbons such as pentane or other hydrocarbons with higher carbon numbers, the carbon dioxide adsorption capacity is higher for 13X than 4A. However, in the presence of hydrocarbons as in natural gas, the adsorption capacity on 13X can be lower than on 4A due to strong competitive adsorption by these hydrocarbons. Selection of a suitable adsorbent then depends on the level of hydrocarbon content in the natural gas.

UOP's SeparSIV is a new adsorption-based technology involving a liquefied natural gas pretreatment step to remove heavy hydrocarbons and to prevent freezing of the heavy hydrocarbons in LNG production. This process uses a layer of large pore adsorbent such as silica gel to remove large hydrocarbon molecules such as C8+ or BTX (benzene, toluene or xylene), and uses a layer of 13X zeolite adsorbent to remove smaller hydrocarbon molecules such as C5s, C6s.

However, the multilayer bed described above is not suitable for removing carbon dioxide due to strong competitive adsorption between carbon dioxide and hydrocarbons on 13X zeolite. If both carbon dioxide and hydrocarbons need to be removed in a single adsorption unit, an appropriate adsorbent and/or adsorbent configuration is needed to effectively remove both components in a single unit.

### BRIEF DESCRIPTION OF THE DRAWINGS

FIG. 1 shows a layered configuration for removing water, hydrocarbons and carbon dioxide from a gas stream with two adsorbent units.

FIG. 2 shows a layered configuration for removing water, hydrocarbon and carbon dioxide from a gas stream with a single adsorbent unit.

FIG. 3 shows carbon dioxide adsorption product by a 4A/13A Zeolite with 1% carbon dioxide in the feed.

FIG. 4 shows carbon dioxide adsorption product by a 4A/13A Zeolite with 0.2% carbon dioxide in the feed

### DETAILED DESCRIPTION OF THE INVENTION

The invention uses a layer of adsorbent with preferential adsorption for C8+ and aromatic compounds, a layer of adsorbent with preferential adsorption of carbon dioxide and a layer of adsorbent with preferential adsorption of C7− hydrocarbons. The adsorbents that may be used include silica gel, type A zeolites such as 4A zeolites, type X zeolites such as 13X zeolites, activated carbon, alumina, zeolite Y, mordenite and silicalite. This invention may use a 4A/13X layered adsorber to remove CO₂ and hydrocarbons in a single adsorber unit. In the presence of hydrocarbons, this invented bed configuration removes the bulk of CO₂ by 4A and polishes the CO₂ composition to below 50 ppm by 13X. Simultaneously, light hydrocarbons (C5-C7) can also be removed by 13X to meet product specification for hydrocarbons. This layered bed actually offers the maximum capacity for CO₂, compared to individual 4A or 13X bed. As CO₂ is the governing component for the bed sizing, this layered bed results in a reduction of the adsorption vessel.

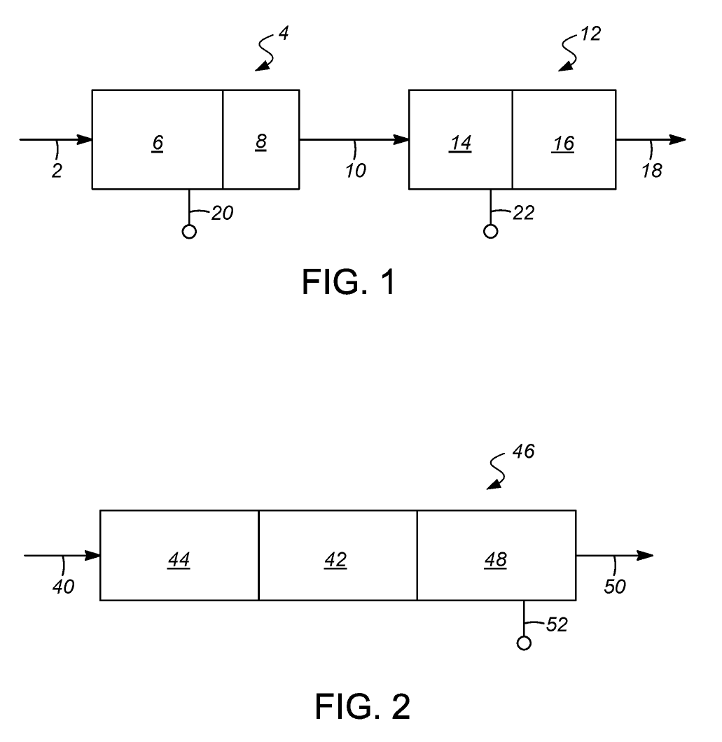

Heavier hydrocarbons (C8+ and BTX) can also be removed by adding a layer of silica gel as in configurations such as shown in FIGS. 1 and 2 which show the two possible configurations of this invention.

The invention employs the use of 4A and 13X adsorbent layers as well as silica gel and other adsorbents as needed to remove other impurities. One source of such zeolites is UOP LLC, Des Plaines, Ill. which markets a 4A zeolite as UI-94 or UI-900. The corresponding products for 13X zeolites are LNG5 and H121 molecular sieves also sold by UOP LLC.

FIGS. 1 and 2 show two layered bed configurations of the present invention. In FIG. 1, a gas feed 2 enters adsorbent bed 4 that contains a silica gel layer 6 to remove C8+ and BTX hydrocarbons and a 4A adsorbent layer 8 to remove water. The resulting partially treated gas 10 then passes to second adsorbent bed 12 that contains a layer 14 of 4A zeolite adsorbent to remove bulk carbon dioxide and a 13X zeolite layer 16 to remove the majority of the remainder of the carbon dioxide and hydrocarbons C7 and lower while retaining methane. A hydrocarbon stream 18 comprising methane is sent to a liquefaction section of the plant. Also, indicated at 20 and 22 are sensors to monitor parameters of adsorbent beds 4 and 12.

FIG. 2 shows a single adsorbent bed having three layers to remove the same impurities as in the two adsorbent bed system of FIG. 1. A gas feed 40 enters adsorbent bed 46 having a silica gel layer 44 to remove C8+ and BTX hydrocarbons, a 4A zeolite layer 42 to remove water and bulk carbon dioxide and a 13X zeolite layer 48 to remove the majority of the remainder of the carbon dioxide and hydrocarbons C7 and lower while retaining methane. A hydrocarbon stream 50 comprising methane is sent to a liquefaction section of the plant. Also, indicated at 52 are sensors to monitor parameters of the adsorbent bed.

Any of the above conduits, unit devices, scaffolding, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

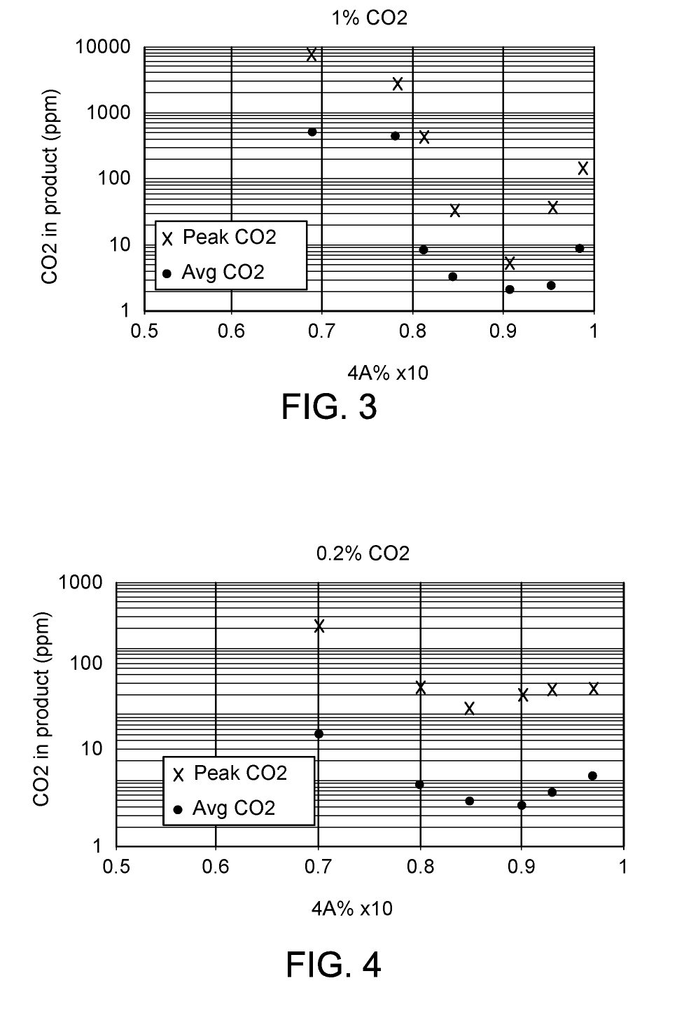

The invention involved the removal of carbon dioxide by a combination of adsorbent 4A zeolite (UI-94) and 13X zeolite (LNGS) with the same overall adsorbent bed size and different split ratio between the two types of zeolites being used. The simulation results show that there is a preferred 4A zeolite (UI-94) to 13X zeolite (LNGS) ratio for carbon dioxide removal. The feed of the investigated case contains about 6600 ppm C3-C6 with 1% and 0.2% carbon dioxide, respectively. In the 1% carbon dioxide case, the optimum adsorbent bed contains about 90% 4A and 10% 13X (FIG. 3). In the 0.2% CO₂ case, the optimum adsorption bed contains about 85% 4A and 15% LNGS (FIG. 4). The layered bed actually offers the best performance for CO₂ removal, compared to individual 4A or 13X bed. The 0.2% CO₂ case requires more LNGS than the 1% CO₂ case. This indicates that the impact of hydrocarbon coadsorption on LNGS is decreased at a low CO₂ composition. Adding a layer of LNGS or 13X at the product end not only serves to remove light hydrocarbons, it also help polishing CO₂ to below 50 ppm.

### Specific Embodiments

While the following is described in conjunction with specific embodiments, it will be understood that this description is intended to illustrate and not limit the scope of the preceding description and the appended claims.

A first embodiment of the invention is a process for treating a natural gas stream comprising sending the gas stream through at least one multi-layered adsorbent bed comprising at least one layer of an adsorbent preferentially adsorbing C8+ hydrocarbons and aromatics over other impurities, at least one layer of a zeolite preferentially adsorbing carbon dioxide over other impurities and at least one layer of a zeolite preferentially removing C7− hydrocarbons over other impurities to produce a gas stream comprising methane. An embodiment of the invention is one, any or all of prior embodiments in this paragraph up through the first embodiment in this paragraph wherein the at least one layer of an adsorbent preferentially adsorbing C8+ hydrocarbons and aromatics comprises silica gel. An embodiment of the invention is one, any or all of prior embodiments in this paragraph up through the first embodiment in this paragraph wherein the at least one layer of a zeolite preferentially adsorbing carbon dioxide is a Type A zeolite. An embodiment of the invention is one, any or all of prior embodiments in this paragraph up through the first embodiment in this paragraph wherein the at least one layer of a zeolite preferentially adsorbing carbon dioxide is a Type 4A zeolite. An embodiment of the invention is one, any or all of prior embodiments in this paragraph up through the first embodiment in this paragraph wherein the at least one layer of a zeolite preferentially removing C7− hydrocarbons is a Type X zeolite. An embodiment of the invention is one, any or all of prior embodiments in this paragraph up through the first embodiment in this paragraph wherein the at least one layer of a zeolite preferentially removing C7− hydrocarbons is a 13X zeolite An embodiment of the invention is one, any or all of prior embodiments in this paragraph up through the first embodiment in this paragraph comprising sending the gas stream to one adsorbent bed comprising three layers of adsorbent. An embodiment of the invention is one, any or all of prior embodiments in this paragraph up through the first embodiment in this paragraph comprising sending the gas stream to two adsorbent beds in sequence. An embodiment of the invention is one, any or all of prior embodiments in this paragraph up through the first embodiment in this paragraph wherein the gas stream is first sent through a first adsorbent bed, contacting a silica gel layer and then a 4A zeolite layer; then the gas stream is sent through a second adsorbent bed first contacting a second 4A zeolite layer and then contacting a 13X zeolite layer producing a gas stream comprising methane. An embodiment of the invention is one, any or all of prior embodiments in this paragraph up through the first embodiment in this paragraph wherein the gas stream comprising methane is sent to be liquefied. An embodiment of the invention is one, any or all of prior embodiments in this paragraph up through the first embodiment in this paragraph wherein the aromatic hydrocarbons are selected from the group consisting of benzene, toluene and xylene. An embodiment of the invention is one, any or all of prior embodiments in this paragraph up through the first embodiment in this paragraph wherein the 4A zeolite layer removes water and bulk amounts of carbon dioxide. An embodiment of the invention is one, any or all of prior embodiments in this paragraph up through the first embodiment in this paragraph wherein the 13X zeolite layer removes C7− and carbon dioxide allowing methane to join the gas stream comprising methane. An embodiment of the invention is one, any or all of prior embodiments in this paragraph up through the first embodiment in this paragraph wherein the gas stream comprises less than 50 ppm by mole carbon dioxide. An embodiment of the invention is one, any or all of prior embodiments in this paragraph up through the first embodiment in this paragraph further comprising at least one of sensing at least one parameter of the process and generating a signal from the sensing; sensing at least one parameter of the process and generating data from the sensing; generating and transmitting a signal; generating and transmitting data.

A second embodiment of the invention is a system for treating natural gas comprising at least one adsorbent bed comprising layers of adsorbent wherein a first layer comprises a silica gel layer, a second layer comprises a 4A zeolite layer and a third layer comprises a 13X zeolite layer. An embodiment of the invention is one, any or all of prior embodiments in this paragraph up through the second embodiment in this paragraph comprising one or more adsorbent beds in series wherein within the adsorbent beds are positioned at least one layer of adsorbent that preferentially removes C8+ hydrocarbons and aromatics, at least one layer of an adsorbent that preferentially adsorbs carbon dioxide and at least one layer of an adsorbent that preferentially adsorbs C7− hydrocarbons.

1. A process for treating a natural gas stream comprising sending said gas stream through at least one multi-layered adsorbent bed comprising at least one layer of an adsorbent preferentially adsorbing C8+ hydrocarbons and aromatics over other impurities, at least one layer of a zeolite preferentially adsorbing carbon dioxide over other impurities and at least one layer of a zeolite preferentially removing C7− hydrocarbons over other impurities to produce a gas stream comprising methane.

2. The process of claim 1 wherein said at least one layer of an adsorbent preferentially adsorbing C8+ hydrocarbons and aromatics comprises silica gel.

3. The process of claim 1 wherein said at least one layer of a zeolite preferentially adsorbing carbon dioxide is a Type A zeolite.

4. The process of claim 1 wherein said at least one layer of a zeolite preferentially adsorbing carbon dioxide is a Type 4A zeolite.

5. The process of claim 1 wherein said at least one layer of a zeolite preferentially removing C7− hydrocarbons is a Type X zeolite.

6. The process of claim 5 wherein said at least one layer of a zeolite preferentially removing C7− hydrocarbons is a 13X zeolite

7. The process of claim 1 comprising sending said gas stream to one adsorbent bed comprising three layers of adsorbent.

8. The process of claim 1 comprising sending said gas stream to two adsorbent beds in sequence.

9. The process of claim 1 wherein said gas stream is first sent through a first adsorbent bed, contacting a silica gel layer and then a 4A zeolite layer; then said gas stream is sent through a second adsorbent bed first contacting a second 4A zeolite layer and then contacting a 13X zeolite layer producing a gas stream comprising methane.

10. The process of claim 1 wherein said gas stream comprising methane is sent to be liquefied.

11. The process of claim 1 wherein said aromatic hydrocarbons are selected from the group consisting of benzene, toluene and xylene.

12. The process of claim 4 wherein said 4A zeolite layer removes water and bulk amounts of carbon dioxide.

13. The process of claim 6 wherein said 13X zeolite layer removes C7− and carbon dioxide allowing methane to join said gas stream comprising methane.

14. The process of claim 1 wherein said gas stream comprises less than 50 ppm by mole carbon dioxide.

15. The process of claim 1 further comprising at least one of:
sensing at least one parameter of the process and generating a signal from the sensing;
sensing at least one parameter of the process and generating data from the sensing;
generating and transmitting a signal;
generating and transmitting data.

16. A system for treating natural gas comprising at least one adsorbent bed comprising layers of adsorbent wherein a first layer comprises a silica gel layer, a second layer comprises a 4A zeolite layer and a third layer comprises a 13X zeolite layer.

17. The system of claim 16 comprising one or more adsorbent beds in series wherein within said adsorbent beds are positioned at least one layer of adsorbent that preferentially removes C8+ hydrocarbons and aromatics, at least one layer of an adsorbent that preferentially adsorbs carbon dioxide and at least one layer of an adsorbent that preferentially adsorbs C7− hydrocarbons.
